(19) United States
(12) Patent Application Publication
(10) Pub. No.: US 2003/0104851 A1
(43) Pub. Date: Jun. 5, 2003

(54) Apparatus for and method of playing twenty-one

(76) Inventor: Naftali Merari, Tel Aviv (IL)

Correspondence Address: DICKSTEIN SHAPIRO MORIN & OSHINSKY LLP, 2101 L STREET NW, WASHINGTON, DC, 20037-1526, US

(21) Appl. No.: 10/302,966

(22) Filed: Nov. 25, 2002

Related U.S. Application Data
(60) Provisional application No. 60/333,737, filed on Nov. 29, 2001.
(60) Provisional application No. 60/400,703, filed on Aug. 5, 2002.

(51) Int. Cl. A63F 13/00

(52) U.S. Cl. 463/12

(57) ABSTRACT

An apparatus for and method of playing the game of twenty-one (or any other predetermined point value) is provided. In a preferred embodiment, a dealer and at least one player are each dealt an initial series of cards (e.g., two in number, three in number, etc.), creating a player's hand and a dealer's hand. A player may elect to draw additional cards up to a predetermined player's limit (e.g., limit of drawing only one additional card) until the player's hand has a total point value (TPV) no greater than a predetermined object value limit (e.g., 21). In accordance with another preferred embodiment of the invention, at least one player is dealt an initial series of cards (e.g., two in number, three in number, etc.), creating a player's hand. A player may elect to hold or replace cards in the initial series up to a predetermined player's limit (e.g., limit of replacing all initially dealt cards). The cards that the player has elected to replace are discarded and new cards drawn in their place. Subsequently, the total point value of the cards in the remaining hand is determined for the player's hand.

This application derives from and claims the benefit of U.S. Provisional Application No. 60/333,737, filed Nov. 29, 2001, and U.S. Provisional Application No. 60/400,703, filed Aug. 5, 2002, the disclosures of which are both incorporated herein be reference in their entireties.

### BACKGROUND

The constant development of games and game systems is required in order to maintain player/user interest in playing games. Casino and arcade operators, for example, have a keen interest in the development in order to maintain or enhance visits and participation in their respective establishments. Operators originally relying heavily on dealer tables offering traditional card games such as poker and blackjack, or mechanical slot machines, now rely heavily on processor-based video games offering the same games to cater to the tastes of the players/users. Continued variation and enhancement of games and game systems is required to maintain or increase the level of enthusiasm of today's players/users.

### SUMMARY

An apparatus for and method of playing the game of twenty-one (or any other predetermined point value) is provided. In a preferred embodiment, a dealer and at least one player are each dealt an initial series of cards (e.g., two in number, three in number, etc.), creating a player's hand and a dealer's hand. A player may elect to draw additional cards up to a predetermined player's limit (e.g., limit of drawing only one additional card) until the player's hand has a total point value (TPV) no greater than a predetermined object value limit (e.g., 21). In a preferred embodiment, the dealer is required to draw additional cards up to a predetermined dealer's limit (e.g., limit of drawing only one additional card) if the dealer's hand has a total point value of some predetermined threshold value (e.g., 16) or less. Subsequently, the respective total point values are determined for the dealer's hand and the player's hand. Different outcomes based on the determined point values can be assigned (positive and negative) payouts, credits or other awards. In a preferred embodiment, for example, the participant with the largest total point value in its hand with a total point value that does not exceed the predetermined object value (e.g., 21) is declared the winner.

In accordance with another preferred embodiment of the invention, at least one player is dealt an initial series of cards (e.g., two in number, three in number, etc.), creating a player's hand. A player may elect to hold or replace cards in the initial series up to a predetermined player's limit (e.g., limit of replacing all initially dealt cards). The cards that the player has elected to replace are discarded and new cards drawn in their place. Subsequently, the total point value of the cards in the remaining hand is determined for the player's hand. Different outcomes based on the determined point values can be assigned (positive and negative) payouts, credits or other awards. In a preferred embodiment, for example, if the remaining hand constitutes a three of a kind (i.e., numerical indicia on each card is the same) and the predetermined point value is met (e.g., TPV=“21”), a payout in accordance with a predetermined schedule (e.g., 20 to 1) is provided to the player.

### BRIEF DESCRIPTION OF DRAWINGS

FIG. 1 illustrates a game playing system in accordance with a preferred embodiment of the invention;

FIGS. 2, 3a and 3b illustrate process flow for game playing in accordance with a preferred embodiment of the invention;

FIG. 4 illustrates an exemplary implementation of a preferred embodiment of the invention embodied in an up-right, stand-alone structure;

FIG. 5 illustrates a blackjack table for use in an exemplary implementation of a preferred embodiment of the invention;

FIGS. 6a and 6b illustrate an exemplary implementation of a preferred embodiment of the invention in the form of a video card game;

FIGS. 7a, 7b and 7c illustrate exemplary implementations of preferred embodiments of the invention in the form of video 21 games; and

FIG. 8 illustrates an exemplary implementation of enhancements of preferred embodiments of the invention.

### DETAILED DESCRIPTION

Preferred embodiments and applications of the invention will now be described. Other embodiments may be realized and structural or logical changes may be made to the disclosed embodiments without departing from the spirit or scope of the invention. Although the preferred embodiments disclosed herein have been particularly described as applied to the playing of casino-type games (or other games of chance) through manual or electronic devices, it should be readily apparent that the invention may be embodied to implement any game and/or game implementation technology having the same or similar problems.

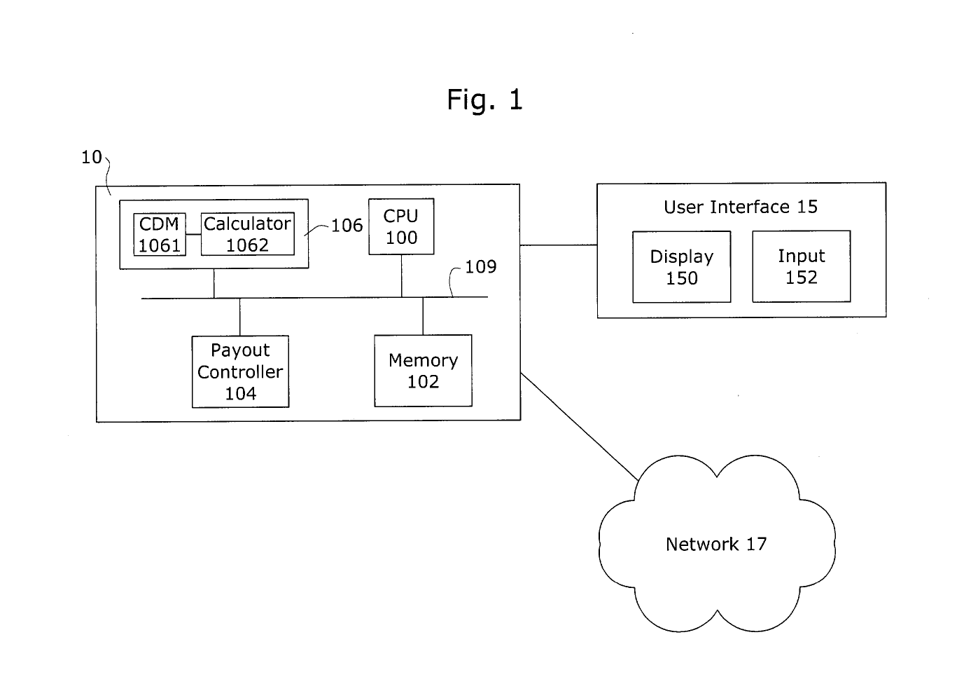

The system illustrated in FIG. 1 is composed of a game server 10 and user interface 15 for implementing the game operations described below in accordance with preferred embodiments of the invention. (It should be apparent, however, that many, if not all, of the game operations may be implemented by hand using physical devices (e.g., one or more deck(s) of cards), and human intervention (e.g., house dealer) in accordance with the teachings herein.) In accordance with a preferred embodiment, game server 10 may include one or more central processing units (CPUs) or other calculating or processing devices, symbolically represented by CPU 100, used to provide processing of input/output data between game server 10, user interface 15, and/or network 17, and among the different modules (all connected together via system bus 109) within game server 10. CPU 100 typically executes one or more computer programs stored in the one or more memory devices symbolically represented as memory module 102.

An award determination unit/payout controller 104 is provided to determine whether an award or payout should be issued to a player/user based on results of one or more hands played. Game controller 106 is provided to control processing of the individual hands played by one or more users in accordance with the preferred embodiments described in (or apparent from) the instant disclosure. User interface 15 provides one or more output devices such as display device 150 (e.g., CRT, LCD, or other known output devices) and one or more input devices 152 (e.g., touch screen interface, keyboard, mouse, stylus, push button, or other known input mechanisms) for facilitating the play of one or more hands by one or more users. (The “display,” for example, represents an electronic embodiment of the invention presented on a video display (e.g., CRT, LCD, or other video screen), as well as a manual embodiment using a physical deck of cards (or other objects or indicia of value) displayed on a card table or the like.)

Network 17 may take any wired/wireless form of known connective technology (e.g., PCI bus, firewire, USB, internal LAN, enterprise WAN, intranet, Internet, Virtual Private Network (VPN), etc.) to allow game server 10 to provide local/remote information and control data to/from other locations. In accordance with a preferred embodiment of the invention, the game server may be implemented in stand-alone devices (e.g., personal computers, gaming systems, etc.) or network devices, as well as serving one or more users over a collection of remote and disparate networks (e.g., Internet, intranet, VPN, LAN, etc.).

In a preferred embodiment, game controller 106 is composed of a card distribution module (CDM) 1061, which is provided to distribute or assign indicia or other value markers (e.g., cards) during iterations (e.g., hands) of the game, and a calculator module 1062, which is provided to determine and compare the number of cards to be drawn relative to predetermined limits (e.g., players limit, dealer's limit), and determine and compare Total Point Value (“TPV”) of cards of the player's hand with the dealer's hand at the conclusion of the game.

The term “card” or “value marker,” as used herein, refers to any thing (real or simulated) that can be assigned value such as a numerical or point value (or series of point values). The point value assigned to a card may be added to another card or series of cards resulting in a TPV for the cards in one or more particular hands. In one exemplary embodiment, “cards” refers to a standard deck of playing cards arranged in four suits designated as hearts, clubs, diamonds and spades. Each suit consists of 13 cards, the first 9 of which are assigned a face value in series ranging from numerical values of 2-10. Three cards (jack, queen, king) are assigned a face value of numerical value 10, while the ace is assigned a numerical value of 1 or 11 (predetermined prior to dealing, or decided during play). A standard deck of playing cards may also include one or more cards (e.g., designated as the Joker) that may optionally be assigned a point value (e.g., 0 or more/less). Any number (or type) of cards (or decks of cards) may be used, however.

The cards may be physical units of any size or shape, adorned with any graphic or text, and arranged in any manner desired. In an embodiment, cards may be simulated or represented electronically through use of a computer program, subroutine or instructions, and displayed on a display or other output device in the form of an icon, avatar or any other sensory perceived arrangement.

The CDM, which in the preferred embodiment symbolically represents a “dealer,” may be in the form of a person, a computer program, subroutine, or set of instructions, or in any other form or format, electronic, mechanical or organic, having the capability of distributing or assigning cards to players. A player or dealer may receive or be assigned a card by “drawing” or requesting assignment of a card from the dealer. In the case of a computer program, subroutine, or instructions, the CDM may be displayed on a computer monitor or display in any form or electronic representation, avatar, icon or any other sensory arrangement, or not displayed at all.

A calculator module 1062 is provided to determine and compare the TPV of a player's hand and the dealer's hand. The calculator module 1062 may be fully or partially integrated into the CDM 1061 or may be provided as a completely separate unit. For example, a dealer may be both the CDM 1061 and the calculator module 1062. Likewise, a computer program may embody both the CDM 1061 and the calculator module 1062.

The game system described above may be used to effectuate any one or more aspects of the game operations described in (and apparent from) the specific embodiments, implementations, and illustrations provided herein.

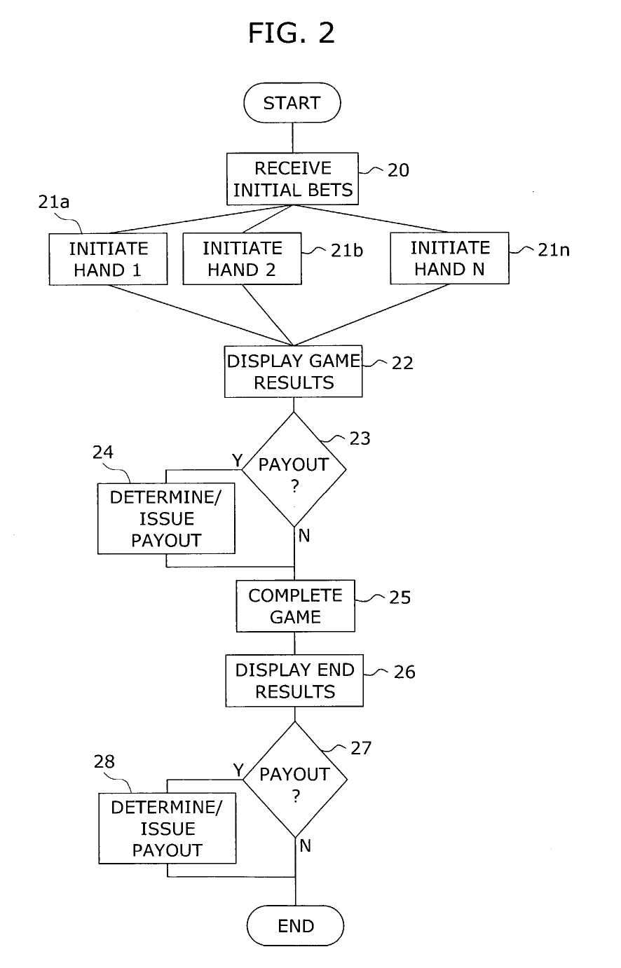

In accordance with a preferred embodiment of the invention, a process or method (FIG. 2) is implemented (e.g., through use of the system illustrated in FIG. 1, through any other system, or by human intervention) for playing a game (e.g., card game). Initially, if applicable, initial bets, wagers, or offering of at-risk credits or value points are made by one or more users and received (e.g., by payout controller 104, or a house dealer) (at step 20). One or more (e.g., series of) value markers (e.g., cards) are distributed or otherwise assigned to each of one or more users in a game. The markers, in this exemplary embodiment, may take the form of cards in a dealt hand, one for each user, and, optionally, one for the “house” or “dealer” designee (if not a user), which are all initiated and displayed (e.g., on display device 150, on dealer card table, etc.) (at steps 21a, 21b, . . . 21n). The initial results of the running of the game are determined (e.g., by game controller 106, by house dealer, etc.) and displayed (at step 22), as will be described in more detail below.

If applicable, a determination may be made (e.g., by pertinent game controller 106 and/or payout controller 104, by dealer, etc.) as to whether any payouts (or other awards) are to be given based on the initial results (at step 23). If a payout or award is to be made, the amount to be paid out (or otherwise awarded) is determined, and the payout (or other award credit) issued (e.g., by pertinent game controller 106 and/or payout controller 104, by dealer, etc.) (at step 24). The game is then operated in conjunction with any applicable directions (e.g., request for cards, etc.) as made by the user (e.g., through input device 152, by the player hand signaling to the dealer, etc.) in accordance with the embodiments of the game described below until the game is completed (at step 25). The end results of the game are then displayed (at step 26), and a determination and issuance of payout (or other award credits) made (at steps 27 and 28) in a manner similar to that described above (in connection with steps 23 and 24).

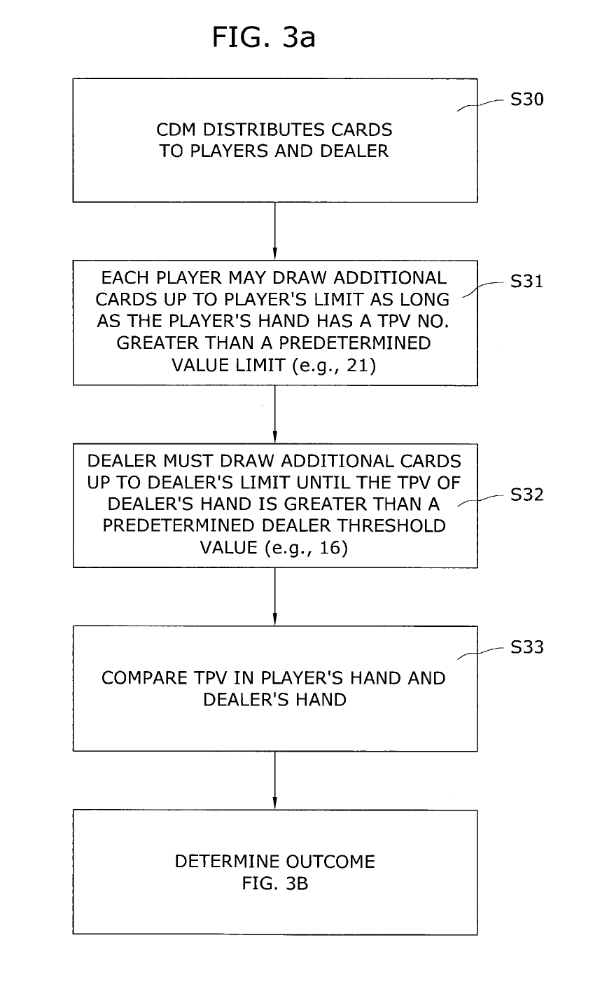

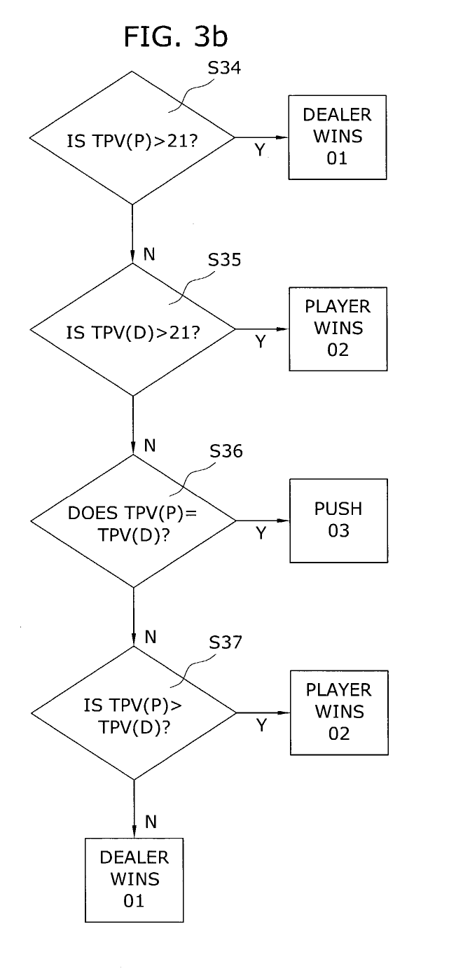

In operation, the exemplary embodiment described above allows the system to execute a card game in accordance with the operational flow depicted in FIGS. 3a and 3b in (steps S30 through S37), as described below. FIGS. 3a and 3b also describe a method of playing a card game in accordance with a preferred embodiment of the invention.

In a preferred embodiment, CDM 1061 assigns or otherwise deals an initial series of cards to each player and to the “house” or “dealer” designee (which may be one of the players) (step S30) to respectively represent player and dealer hands. In an exemplary embodiment of the invention, the initial series of cards totals “2” in number. Each player may optionally receive (i.e., “draw”) additional cards from CDM 1061 up to a predetermined player's limit (as determined and tracked by CDM 1061) as long as the total point value (TPV) of the cards in the player's hand is no greater than a predetermined object value. In this exemplary embodiment, the limit on drawn cards is “1” (to make a total of “3” cards in the player's hand) and the predetermined object value is “21” (step S31). In an embodiment, CDM 1061 may be required to draw additional cards for the dealer's hand up to a predetermined dealer's limit. This predetermined dealer's limit may be the same or different than the predetermined player's limit. In this exemplary embodiment, the predetermined dealer's limit is “1” (to make a total of “3” cards in the dealer's hand) and the amount of cards drawn compared by CDM 1061 to this limit.

In a preferred embodiment of the invention, CDM 1061 is required to repeatedly draw additional cards (up to the predetermined dealer's limit, e.g., “1”) for the dealer's hand until the TPV of all cards in the dealer's hand exceed a predetermined threshold value. In this exemplary embodiment, this predetermined threshold value is “16” (step S32). Alternatively, CDM 1061 is not required to draw additional cards if the dealer has already won the game as described below, and the CDM 1061 is not permitted to draw additional cards if the conditions for the predetermined threshold value have already been met (e.g., TPV (D) exceeds “16”).

After all the required “drawn” cards are dealt, calculator module 1062 calculates TPV (P) and TPV (D), which represent the total point values of the player's hand and dealer's hand, respectively, as reflected by the face value of the cards in the hands, and compares the TPVs (step S33) to determine an outcome, as shown in FIG. 3b (outcomes O1-O3).

If, for example, it is determined (in step S34) that TPV (P) is greater than the predetermined object value (e.g., 21), then the dealer wins (O1). If, on the other hand, it is determined (in step S35) that TPV (D) is greater than the predetermined object value (e.g., 21), then the player wins (O2). If it is determined (in step S36) that TPV (P) is equal to TPV (D), then neither party wins and a “push” (i.e., no winner) is declared (O3) (or some other outcome, e.g., dealer wins, may be assigned). If it is determined (in step S37) that TPV (P) is greater than TPV (D), then the player wins (O2). Otherwise, the dealer wins (O1). Variations on the above-described method and system can add additional excitement to the illustrated embodiments, particularly the determination of outcomes (O1-O3).

Players may win the card game as described above resulting in a player win. The dealer (or other “dealer” designee) may win the card game as described above resulting in a dealer win. A player win may optionally result in a player receiving some multiple (or, in the alternative, a fraction) of the value of the player's bet or wager. Receiving payment as a result of a player's bet or wager is alternatively termed herein a “payout.” In accordance with a preferred embodiment, a number of different payouts can result from a player win, as illustrated in the following scenarios.

If the TPV (P) of each of the first two cards assigned or dealt to a player are equal, then the player has the option of “splitting” the cards to form two different player hands. This technique is termed “splitting pairs,” and may increase the probability that the player will receive a payout depending on the face value of the cards.

In a preferred embodiment, the processor-based system and corresponding methods shown and described in relation to FIGS. 3a and 3b (alone or in conjunction with other devices or systems) can be used to implement the scenarios illustrated above.

The system and method for playing a card game described herein may be executed in a variety of venues and configurations. For example, the card game may be played by hand in a casino with a dealer and at least one player in a manner similar to blackjack and other related games. In addition, the card game may be played using a computer where the computer acts as one or more of the CDM, calculator module, and player(s). The card game may also be played with players and the dealer assuming multiple roles such as players taking turns as a dealer. Alternatively, the card game may be played among multiple players wherein each player's hand is compared with other player's hands to determine a winner.

The following examples are intended to further illustrate a preferred embodiment of the invention. Numerous outcomes and payouts can be developed in accordance with the invention. In these illustrated examples, the predetermined object point value is “21,” the predetermined player's and dealer's limit for drawing additional cards is “1,” the dealer is required to draw another card where the dealer's TPV (D) is less than a predetermined threshold value of “17,” and the dealer is not permitted to draw another card where the TPV (D) is equal to or greater than the predetermined threshold value of “17.”

### EXAMPLE 1

In the following example, the TPV (P) of the player's hand is greater than the TPV (D) of the dealer's hand (but at or below the predetermined object value (e.g., 21)), and therefore, the player wins.

| Card Number | Player | Dealer |
|---|---|---|
| 1^{st} Card | 8 | 10 |
| 2^{nd} Card | 7 | 2 |
| 3^{rd} Card | 6 | 8 |
| Total Point Value | 21 | 20 |
| Outcome | Player Wins | |

### EXAMPLE 2

In the following example, TPV (D) is greater than the TPV (P) and neither the player nor the dealer's TPV exceeds the predetermined object value (e.g., 21). Note: the dealer was not permitted in this example to draw another card after the initial hand was dealt.

| | | |
|---|---|---|
| CARD NUMBER | PLAYER | DEALER |

| | | | |
|---|---|---|---|
| 1^{st} Card | 6 | | 10 |
| 2^{nd} Card | 10 | | 8 |
| 3^{rd} Card | 0 | (Joker) | |
| Total Point Value | 16 | | 18 |
| Outcome | | | Dealer |
| | | | Wins |

### EXAMPLE 3

In the following example, the TPV (P) of the player's hand is greater than the TPV (D) of the dealer's hand, and, and therefore, the player wins. Note: the dealer cannot draw additional cards to increase its TPV (D) beyond “12” because the limit for drawing additional cards is “1” in this example.

| Card Number | Player | Dealer |
|---|---|---|
| 1^{st} Card | 5 | 6 |
| 2^{nd} Card | 5 | 2 |
| 3^{rd} Card | 3 | 4 |
| Total Point Value | 13 | 12 |
| Outcome | Player Wins | |

### EXAMPLE 4

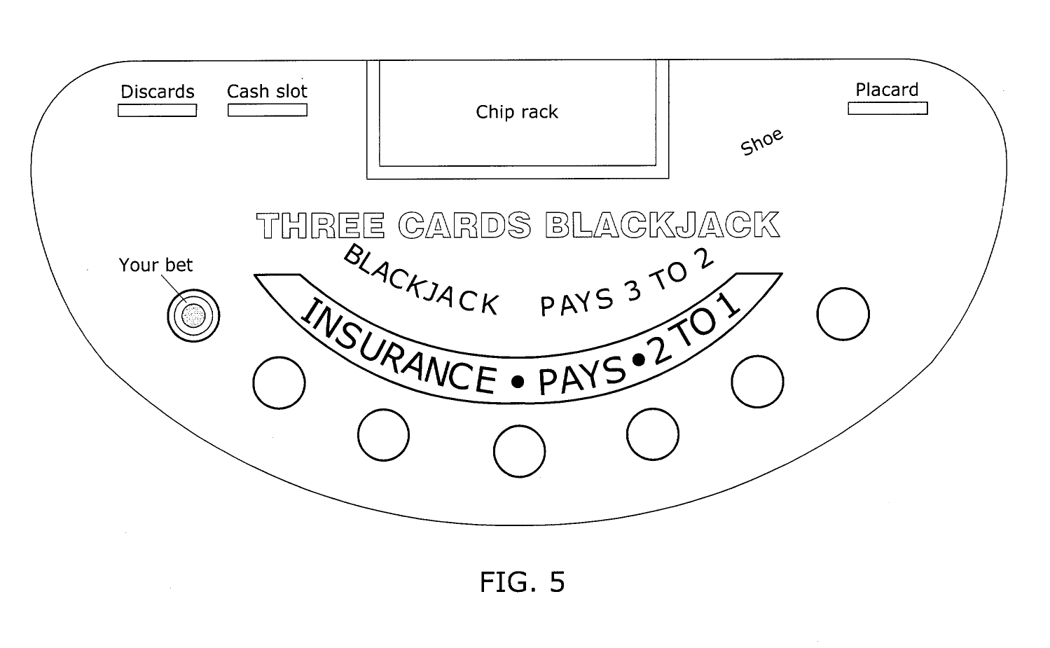

In the following example, a casino-style game of blackjack is provided. The blackjack game may be implemented manually, through a computer program-implemented device, or through any system in accordance with the teachings herein. The game may be used in conjunction with the (real or simulated) blackjack table shown in FIG. 5.

Blackjack Rules

Before any cards are dealt, the player must wager. He does this by placing his bet in the designated space in front of his table position. The dealer then deals two cards to each of the players, and two to himself (one of the dealer's cards is dealt face up and one is dealt facing down). Face cards (kings, queens and jacks) count as 10, ace counts as one or 11 (as the player chooses) and all other cards are counted at their face value.

BLACKJACK—If the player's first two cards are an ace and a 10 or face card, he wins. However, if the dealer also has a blackjack, it is a standoff, as are all ties or pushes. A winning blackjack pays the player 3 to 2.

HIT or STAND—Hit means to draw another card (which the player may signify by scraping the table with his cards, a similar hand motion, or other input or indication). Stand means no more cards (which the player may signal by placing his cards under his wager or moving his hand in a horizontal direction. If the player hits and busts (goes over 21), he immediately turns his cards over and his wager is lost.

DOUBLE DOWN—The player is allowed to double the bet on his first two cards and draw one additional card only to improve his hand.

SPLITTING PAIRS—If the first two cards a player is dealt are a pair, he may split them into two separate hands, bet the same amount on each and then play them separately. Aces receive only one additional card. After splitting, A-10 counts as 21 and not as blackjack.

INSURANCE—If the dealer's up card is an ace, the player may take insurance, a bet not exceeding one-half his original bet. If the dealer's down card is a 10 or any face card, the player wins 2 to 1. Any other card means a win for the dealer.

SURRENDER—Where permitted, a player may give up his first two cards and lose only one-half of his original bet.

The dealer must draw on 16 and stand on 17. In some casinos, the dealer is required to draw on soft 17 (i.e., Ace and 6).

In accordance with another preferred embodiment of the invention, a process or method is implemented (e.g., through use of the system illustrated in FIG. 1, through any other system, or by human intervention) for playing a game (e.g., card game). Initially, if applicable, initial bets, wagers, or offering of at-risk credits or value points are made by one or more users and received (e.g., by payout controller 104, or a house dealer). One or more (e.g., series of three) value markers (e.g., cards) are distributed or otherwise assigned to each of one or more users in a game. The markers, in this exemplary embodiment, may take the form of cards in a dealt hand, one for each user, which are all initiated and displayed (e.g., on display device 150, on dealer card table, etc.). The initial results of the running of the game are determined (e.g., by game controller 106, by house dealer, etc.) and displayed, as will be described in more detail below.

If applicable, a determination may be made (e.g., by pertinent game controller 106 and/or payout controller 104, by dealer, etc.) as to whether any payouts (or other awards) are to be given based on the initial results. If a payout or award is to be made, the amount to be paid out (or otherwise awarded) is determined, and the payout (or other award credit) issued (e.g., by pertinent game controller 106 and/or payout controller 104, by dealer, etc.). The game is then operated in conjunction with any directions (e.g., request for cards, etc.) as made by the user (e.g., through input device 152, by the player hand signaling to the dealer, etc.) in accordance with the embodiments of the game described below until the game is completed. The end results of the game are then displayed, and a determination and issuance of payout (or other award credits) made in a manner similar to that described above.

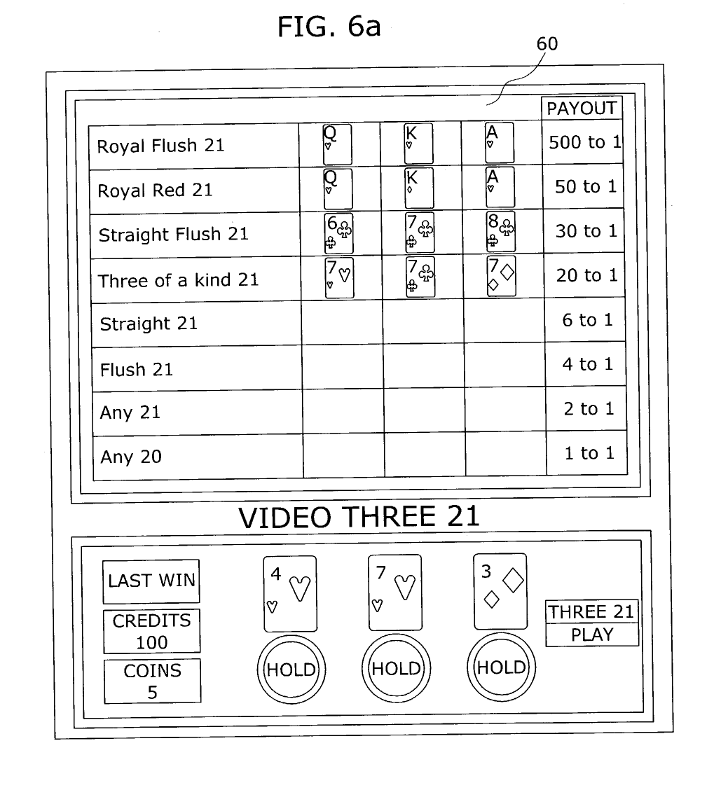

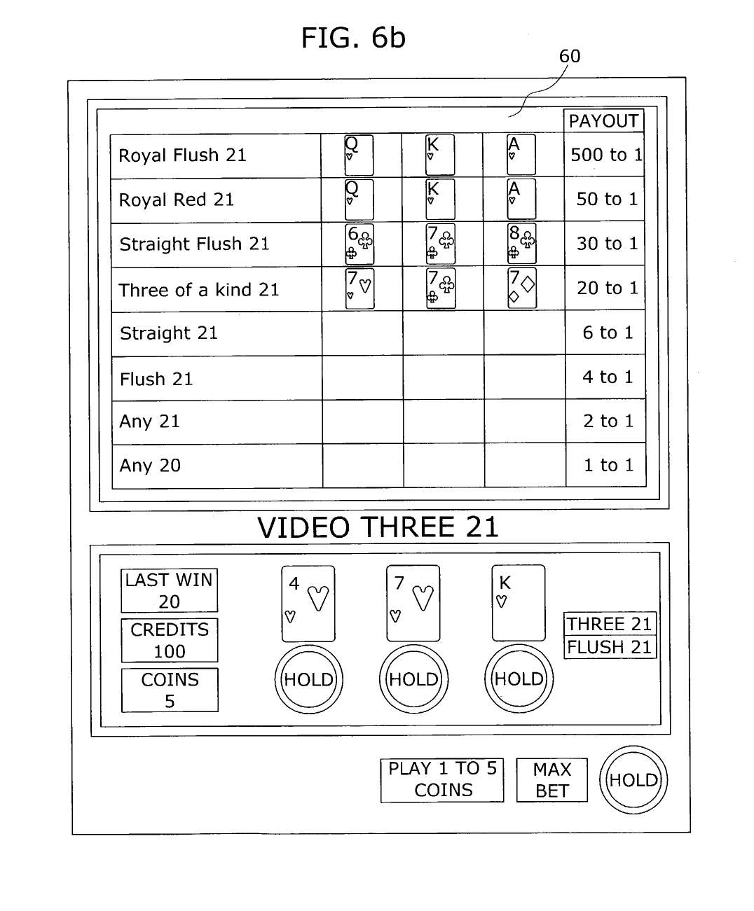

In this embodiment, CDM 1061 assigns or otherwise deals an initial series of cards to each player to respectively represent player hands. In an exemplary embodiment of the invention, the initial series of cards totals “3” in number. (An illustration of an exemplary implementation in the form of a video card game is shown in FIG. 6a, with the initial series of cards being dealt as: 4♥; 7♥; and 3♦.) Each player may optionally designate or elect cards in the initial series for discarding and replacement with additional (i.e., “draw”) cards from CDM 1061 up to a predetermined player's limit (as determined and tracked by CDM 1061). (As illustrated in FIG. 6a, the player has elected to “hold” the 4♥ and 7♥, and discard the 3♦.) Optional limits may be placed such as permitting continued play as long as the total point value (TPV) of the cards in the player's hand is no greater than a predetermined object value. In this exemplary embodiment, the limit on drawn cards is “3” (to allow all the cards in the player's initial hand to be replaced) and the predetermined object value is “21.” (In an embodiment, CDM 1061 may be required to deal (or otherwise keep track of) a dealer's hand.)

After all the required “drawn” cards are dealt, calculator module 1062 calculates TPV (P) which represents the total point value of the player's hand (and, in an alternative embodiment, TPV (D), which represents the total point value of the dealer's hand), as reflected by the face value of the cards in the remaining hand(s), and compares the TPV to a predetermined schedule to determine an outcome. (As illustrated in FIG. 6b, the “drawn” card is a K♥, which results in a TPV (P) of 21, and, in particular, an outcome matching the criteria for a “Flush 21.” The payout for this outcome is designated as a multiple of the initial wager by a factor of four i.e., “4-to-1”.)

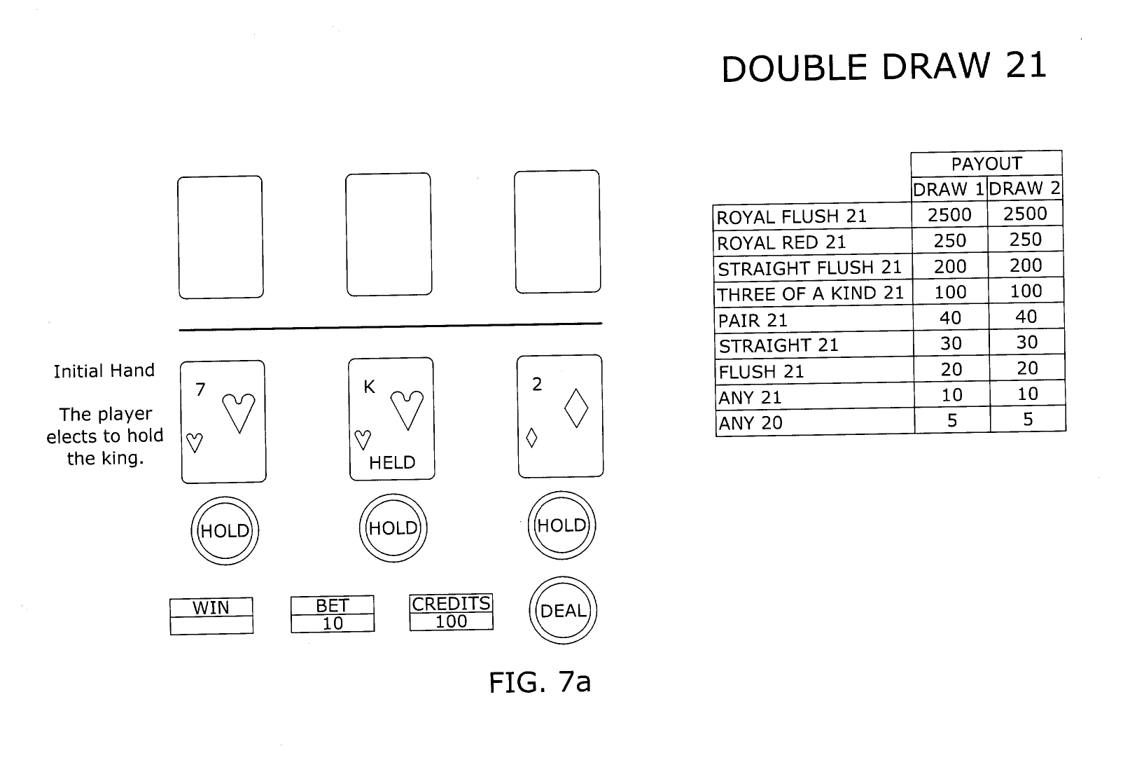

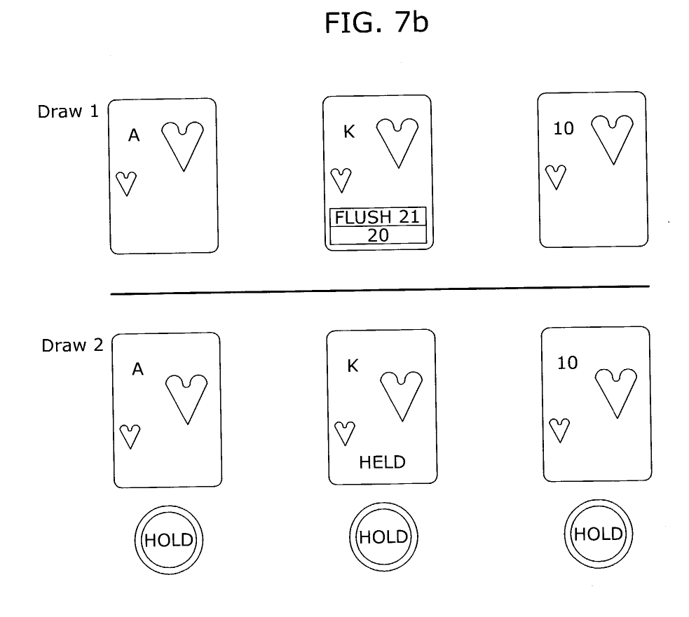

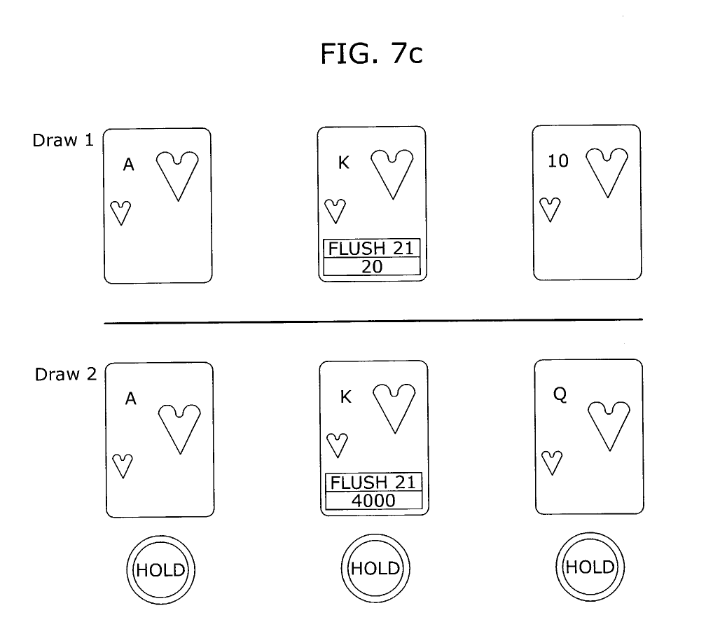

Variations on the above-described method and system can add additional excitement to the illustrated embodiments, particularly the determination of outcomes. As shown in FIGS. 7a and 7b, for example, additional draws (e.g., double draw, triple draw, etc.) may be permitted to allow a player to further discard cards (e.g., only from the originally dealt cards, only from cards received from a prior draw, any currently held card, etc.), and replace them with another draw of the same number of cards. In FIG. 7a, an initial hand of 7♥, K♥ and 2♦ is dealt. The user is shown placing a “hold” on the K♥, and seeking a draw of two cards. In FIG. 7b, the first draw results in a new hand of A♥, K♥ and 10♥. As shown, a second draw is sought by holding the A♥ and K♥. The results of the second draw are shown in FIG. 7c, together with the results of the first draw. Preferably, such “redraws” will be limited to a predetermined number (e.g., 1, 2, 3, etc.) and will reduce the payout the held hand would otherwise receive (e.g., upon redraw no payout for a pair, payout only when subsequent draw is better than prior draw, etc.). An additional variation may allow a player to designate in advance a “target value” of a hand (e.g., three of a kind). The player is permitted to redraw cards (up to a predetermined or maximum number, e.g., 3, 5, no limit, etc., or a maximum number designated by the player in advance) until the player meets (or exceeds) the target value of a hand. The number of redraws needed to obtain the target value would directly affect the amount of the payout (e.g., decreasing payout after each additional redraw). If the target value has not been achieved (or exceeded) after the maximum number of redraws has been completed, the player loses. As further variation, either the designated target value or designated number of draws, or both may be predesignated by the dealer or someone/something (e.g., other players, house rules, the game playing system, etc.) other than the player itself.

Players may win the card game as described above resulting in a player win. (In an alternative embodiment, the dealer (or other “dealer” designee) may win the card game as described above resulting in a dealer win when having a higher TPV than any other player's TPV.) A player win may optionally result in a player receiving some multiple (or, in the alternative, a fraction) of the value of the player's bet or wager. In accordance with a preferred embodiment, a number of different payouts can result from a player win, as illustrated in exemplary payout schedule 60 shown in FIGS. 6a and 6b.

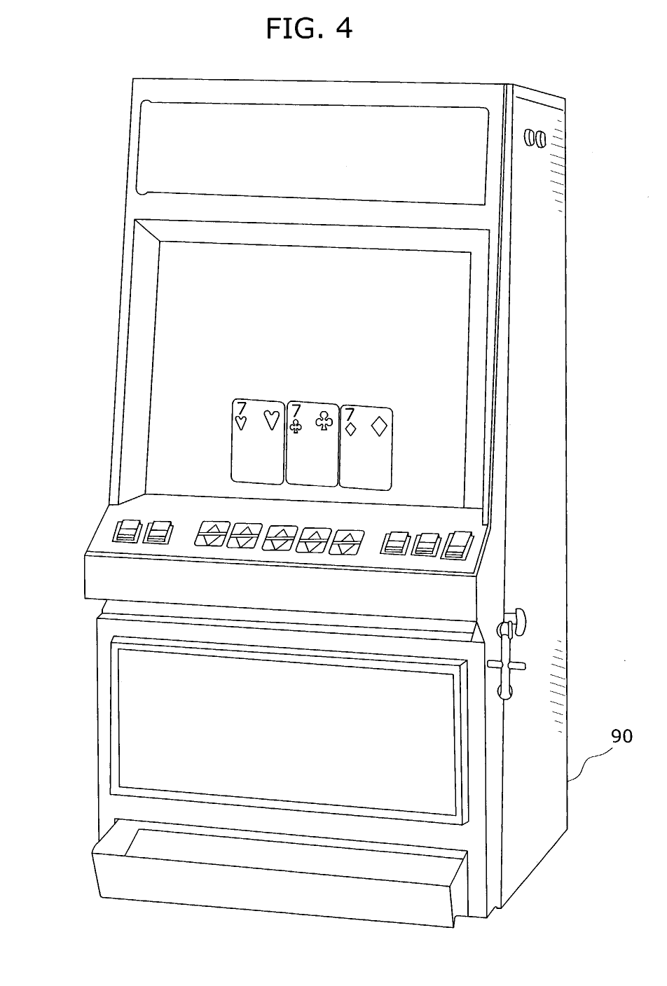

The embodiments described in (or apparent from) the instant disclosure may be employed in stand-alone (or network linked) gaming systems such as the up-right structure 90 illustrated in FIG. 4, as well as in table-top or other structures found in casinos, arcades, and other establishments containing game playing devices. The embodiments may similarly be implemented in other known game systems and platforms (e.g., personal computer, Internet-based, Nintendo Gameboy, Sony Playstation, Sega Genesis, Microsoft X-Box, PDAs, cellphones, portable or hand-held electronic devices, etc.), as well as other gaming formats such as lottery terminals, scratch-card formats, etc.

While preferred embodiments of the invention have been described and illustrated, it should be apparent that many modifications to the embodiments and implementations of the invention can be made without departing from the spirit or scope of the invention. For example, while a card game of twenty-one has been specifically illustrated herein, the invention may easily be deployed or embodied in any form of card/non-card game in accordance with the teachings herein. While the illustrated embodiments have not specified the type of communication medium (or protocol) used to connect the various modules (e.g., shown in FIG. 1), it should be apparent that any known wired/wireless technology may be used to implement the invention (e.g., PCI bus, firewire, USB, Internet, intranets, private bulletin boards, individual local or wide area networks, proprietary chat rooms, ICQ, IRC channels, instant messaging systems, WAP, bluetooth, etc.) using real-time or non-real-time systems alone or in combination. For example, the card game may be played via a network connection (e.g., through Network 17 shown in FIG. 1) with other players or the dealer in a remote location. The card game may be embodied in a Java®-based program or similar application and accessed by players via the Internet on various gaming sites such as Yahoo!® and the like.

In accordance with a preferred embodiment, one or more of the same or different user interfaces (e.g., user interface 15 (FIG. 1)) are provided as part of (or in conjunction with) the illustrated systems to permit one or more users to interact with the systems. Individual ones of a plurality of devices (e.g., network/stand-alone computers, personal digital assistants (PDAs), WebTV (or other Internet-only) terminals, set-top boxes, cellular/PCS phones, screenphones, pagers, kiosks, or other known (wired or wireless) communication devices, etc.) may similarly be used to execute one or more computer programs (e.g., universal Internet browser programs, dedicated interface programs, etc.) to allow users to interface with the systems in the manner described.

The modules described herein, particularly those illustrated or inherent in, or apparent from the instant disclosure, may be one or more hardware, software, or hybrid components residing in (or distributed among) one or more local or remote computer or other processing systems. Although the modules may be shown or described herein as physically separated components (e.g., user interface 15, CPU 100, payout controller 104, game controllers 106, etc.), it should be readily apparent that the modules may be omitted, combined or further separated into a variety of different components, sharing different resources (including processing units, memory, clock devices, software routines, etc.) as required for the particular implementation of the embodiments disclosed (or apparent from the teachings herein). Indeed, even a single general purpose computer (or other processor-controlled device) executing a program stored on an article of manufacture (e.g., recording medium such as a CD-ROM, DVD-ROM, memory cartridge, etc.) to produce the functionality referred to herein may be utilized to implement the illustrated embodiments. User interface devices may be any device used to input and/or output information. The user interface device may be implemented as a graphical user interface (GUI) containing a display or the like, or may be a link to other user input/output devices known in the art.

In addition, memory units described herein may be any one or more of the known storage devices (e.g., Random Access Memory (RAM), Read Only Memory (ROM), hard disk drive (HDD), floppy drive, zip drive, CD-ROM, DVD-ROM, bubble memory, redundant array of independent disks (RAID), storage accessible network (SAN), network accessible storage (NAS), etc.), and may also be one or more memory devices embedded within a CPU, or shared with one or more of the other components.

It should be readily apparent that when implementing various embodiments of the invention, manual devices (e.g., deck of cards and human house dealer, etc.) may be utilized to achieve a game in the manner described above.

The illustrated embodiments have been described herein in connection with possible payouts (or other award credits) being made pursuant to occurrence of events. It should be readily apparent, however, that the term “payout” as used herein can easily be construed to refer to a withdrawal (or other debiting of credits) when used in conjunction with implementations of the invention to effect reduction of payouts (or awards) or even reduction or forfeiture of balances/accounts based on resulting specified individual events or occurrences. The use of predetermined values or limits (e.g., predetermined object value, predetermined player's limit, etc.) are illustrative only, and it should be apparent that any value, limit, etc. may be utilized when implementing an embodiment of the invention. The possible embodiments and implementations of the invention may include any number (e.g., positive, negative, real, imaginary, integer, fraction, zero, etc.) or other indicia of value.

Moreover, the operational flow and method shown in (and described with respect to) FIGS. 2, 3a and 3b can be modified to include additional steps, to change the sequence of the individual steps (e.g., inserting step S36 before or immediately after step S34), as well as combining (or subdividing), simultaneously running, omitting, or otherwise modifying the individual steps shown and described in accordance with the invention. Numerous alternative methods may be employed to produce the outcomes described with respect to the preferred embodiments illustrated above or equivalent outcomes. For example, the outcome of a “push” in step S36 (FIG. 3b) can be modified to designate the winner to the player/dealer who holds the highest card (e.g., Ace “high”) in its hand.

Unlimited variations of the game may be implemented in reducing the invention to practice. In the process of dealing the cards (i.e., either manually or through simulation), for example, the player's cards may be dealt face up, while the dealer's first card is dealt face up and the dealer's second card is dealt face down. After these cards are dealt, the player starts to play. In another exemplary variation, the dealer and each player will be dealt three cards each with no option to draw additional cards, with the outcome based only on the three cards initially dealt. An unlimited number of combinations of variations described in (or apparent from) the disclosure may be made. The option of “splitting” a hand, for example, may be combined with the “double” option to provide enhanced play. In addition, the game that limits drawing of individual cards of a hand to a predetermined limit (e.g., 3 cards) may be further enhanced by permitting discarding and drawing (e.g., possibly including one or more redraws) additional cards to replace the those discarded.

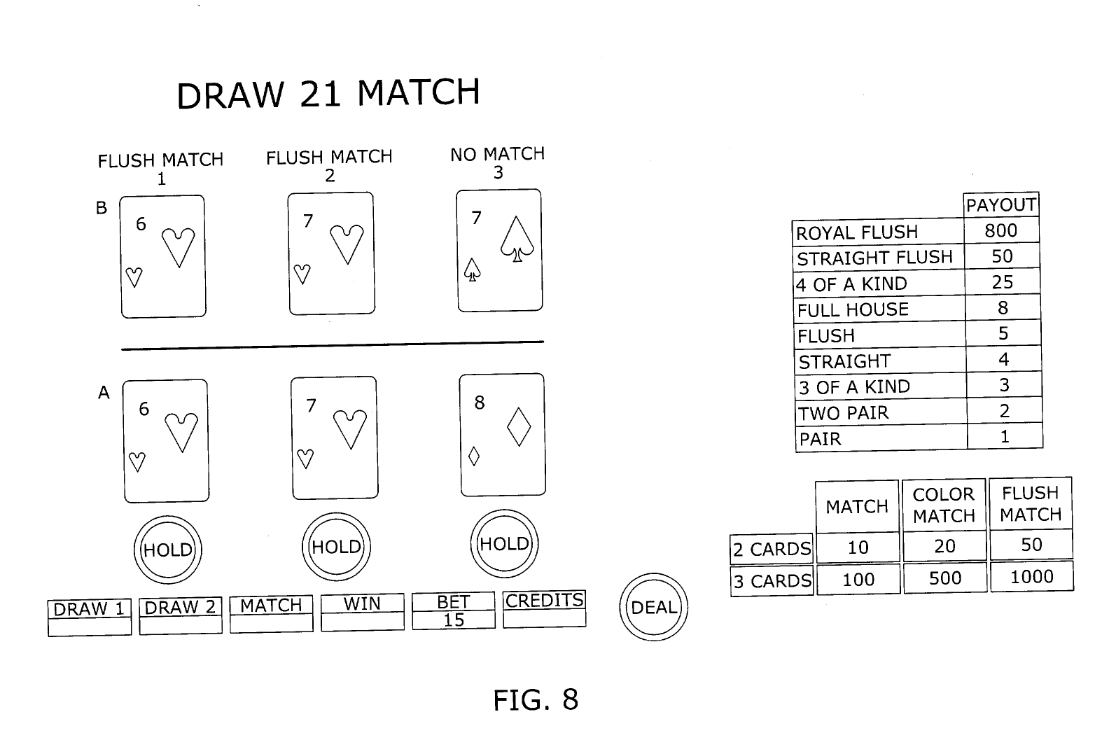

Any of the games (including manual and video games) described herein may be further enhanced by permitting players to play more than one hand at a time. As shown, for example, in FIG. 8 a player is dealt two hands (labeled “A” and “B,” respectively). The hands may be played separately without (or with) reference to each other, each having separate (or combined) payouts depending on their respective values. The hands may be designated to play the same game (i.e., draw 21) or play different games (“A”: draw 21; “B”: 3-card 21). Additionally, a “bonus” feature may be introduced to provide bonus payouts based on certain predetermined relationships between cards held in hands “A” and “B.” As shown in FIG. 8, for example, cards appearing in the same card position (i.e., “1,” “2,” or “3”) for hands “A” and “B” may produce: 1) a “match” payout if they are the same numerical/face value; 2) a “color match” payout if they are the same value and suit and color; and 3) a “flush match” if they are the same value and same suit. This “bonus” feature may be applied whether or not the player decides to place a wager on all of the hands (e.g., both “A” and “B” that are dealt at the time.

Accordingly, the invention is not to be limited by the foregoing description or drawings, but only by the appended claims.

What is claimed:

1. A method of playing a card game comprising the steps of:
(a) dealing a plurality of playing cards constituting an initially dealt player's hand;
(b) determining whether additional cards are to be dealt and added to the player's hand, wherein additional cards are not to be dealt in excess of a predetermined additional card limit;
(c) dealing additional cards based on the determination made in said determining step (b); and
(d) providing a winning payout based on a value of all the playing cards in the player's hand relative to a predetermined value.

2. The method of playing a card game as recited in claim 1, the method further comprising the step of dealing a plurality of cards constituting a dealer's hand, and wherein the winning payout provided in step (d) is based on a comparison between the player's hand and the dealer's hand.

3. The method of playing a card game as recited in claim 2, the comparison between player's and dealer's hands is based on numerical values preassigned to each playing card in the player's and dealer's hands, and wherein said providing step (d) provides a payout if the player's hand has a total numerical value closer to the number twenty one than the total numerical value of the dealer's hand.

4. The method of playing a card game as recited in claim 3, wherein said providing step (d) provides a payout to a player only if the total numerical value of the player's hand is not greater than the number twenty one.

5. The method of playing a card game as recited in claim 2, wherein the predetermined additional card limit is three.

6. The method of playing a card game as recited in claim 2, wherein said step of dealing a plurality of cards constituting a dealer's hand comprises the substep of determining whether additional dealer cards are to be dealt and added to the dealer's hand, wherein additional dealer cards are not to be dealt in excess of a predetermined additional dealer card limit.

7. The method of playing a card game as recited in claim 6, wherein the substep of determining whether additional dealer cards are to be dealt is automatically performed when the total numerical value of the dealer's hand is not greater than a predetermined number, and wherein the predetermined additional dealer card limit is three.

8. The method of playing a card game as recited in claim 1, wherein said dealing step (a) is performed by hand with cards being dealt on a card table.

9. The method of playing a card game as recited in claim 1, wherein said dealing step (a) is performed using a computer programmed to display the initially dealt player's hand on a video screen.

10. The method of playing a card game as recited in claim 1, wherein said dealing step (c) is performed to add additional cards as a replacement for an equal amount of cards in the initially dealt player's hand that have been discarded.

11. A method of playing a card game comprising the steps of:
(a) dealing a plurality of playing cards constituting an initially dealt player's hand;
(b) determining whether any cards are to be withdrawn from the initially dealt player's hand;
(c) dealing additional cards based on the determination made in said determining step (b) to be included in the player's hand; and
(d) providing a winning payout based on a value of all the playing cards in the player's hand relative to a predetermined value.

12. The method of playing a card game as recited in claim 11, wherein said providing step (d) provides a payout to a player only if the total numerical value of the player's hand is not greater than twenty one.

13. The method of playing a card game as recited in claim 11, the method further comprising the step of placing a wager prior to said dealing step (a), and wherein the payout is equal to a first multiple of the wager if the total numerical value of the player's hand is equal to twenty one.

14. The method of playing a card game as recited in claim 13, wherein the payout increases to a second multiple of the wager if the total numerical value of the player's hand is equal to twenty one and all the cards in the player's hand are of the same suit.

15. The method of playing a card game as recited in claim 14, wherein the first multiple is a factor of two and the second multiple is a factor of four.

16. The method of playing a card game as recited in claim 13, wherein the payout is equal to a third multiple of the wager if the total numerical value of the player's hand is equal to twenty one and all the cards in the player's hand have the same numerical value of seven.

17. The method of playing a card game as recited in claim 11, the method further comprising the step of dealing a plurality of cards constituting a dealer's hand, and wherein the winning payout provided in step (d) is based on a comparison between the player's hand and the dealer's hand.

18. The method of playing a card game as recited in claim 12, the comparison between player's and dealer's hands is based on numerical values preassigned to each playing card in the player's and dealer's hands, and wherein said providing step (d) provides a payout if the player's hand has a total numerical value closer to twenty one than the total numerical value of the dealer's hand.

19. The method of playing a card game as recited in claim 12, wherein the total number of cards in the initially dealt player's hand is three.

20. The method of playing a card game as recited in claim 19, wherein said dealing step (a) is performed by a stand-alone computer programmed to display the initially dealt player's hand on a video display terminal.

21. The method of playing a card game as recited in claim 11, wherein said determining step (b) and dealing step (c) are repeated at least once prior to performing said providing step (d).

22. The method of playing a card game as recited in claim 21, wherein prior to performance of said dealing step (a), a target value is determined, and wherein said determining step (b) and dealing step (c) are repeated continuously to form a redrawing step, wherein said redrawing step is performed repeatedly until the target value is achieved by the player, the value of the player's hand exceeds the predetermined value, or said redrawing step is repeated a predetermined number of times.

23. The method of playing a card game as recited in claim 11, wherein said dealing step (a) further comprises dealing a second hand for the player concurrently with the initially dealt hand.

24. The method of playing a card game as recited in claim 23, further comprising the steps of:
comparing individual cards in the second hand with individual cards in the initially dealt hand;
determining whether at least one card in the second hand meets predetermined match criteria constituting a match between the individual cards compared in the second hand and the initially dealt hand; and
providing a match payout based on the match criteria met by the individual cards compared.
